(19) United States
(12) Patent Application Publication
(10) Pub. No.: US 2006/0021476 A1
(43) Pub. Date: Feb. 2, 2006

(54) Jaw portion structure of adjustable spanner

(76) Inventor: Chih-Ching Hsien, Taichung-Hsien (TW)

Correspondence Address: Chih-Ching Hsien, 235 Chung - Ho, Box 8-24, Taipei, TW

(21) Appl. No.: 10/902,412

(22) Filed: Jul. 30, 2004

(51) Int. Cl. B25B 13/16

(52) U.S. Cl. 81/170; 81/165

(57) ABSTRACT

A jaw portion structure of an adjustable spanner comprises an adjustable spanner body including a head portion and a handle; a fixing jaw portion and a sliding trench being extended integrally in the head portion; one side of the fixing jaw portion being formed with a second clamping surface. A movable jaw is installed in the sliding trench; one side of the movable jaw being formed with a first clamping surface corresponding to the second clamping surface; a lower end of the movable jaw being installed with a positioning rod which being positioned to the sliding trench of the head portion. A neck portion is formed between the positioning rod and the movable jaw. One side of the neck portion is formed with an inclined surface connected to the first clamping surface. Each of two sides of the inclined surface is formed with a respective cambered guide surface.

### FIELD OF THE INVENTION

The present invention relates to adjustable spanners, and particular to a jaw portion structure of an adjustable spanner, wherein the screwing element is in surface-contact with the clamping surfaces of the adjustable spanner so that when a force is applied to the adjustable spanner body, the applied force can be uniformly distributed to prevent the screwing element to slide or collapse. Thus the lifetime of the adjustable spanner is prolonged.

### BACKGROUND OF THE INVENTION

With reference to FIGS. 1-1 to 1-3, it is illustrated that the prior art adjustable spanner clamps different kinds of screwing elements. In the prior art, an adjustable spanner 40 has a first surface 411 and a second surface 412 on a fixing jaw 41 and an adjusting jaw 42, respectively. Two lower sides of the adjusting jaw 42 are formed with inclined surfaces 422 so that the adjustable spanner is light. Thereby, shapes of the two jaws have the effect of strengthen the structure. However, the structure is not matched to the requirement of the users.

From FIGS. 1-1 to 1-3, it is illustrated that a screwing element is placed between two surfaces 423 of the two jaws, but the surfaces of the screwing element cannot tightly adhere to the surfaces of the jaws. Only the points 51, 52 are in contact with the jaws so that the screwing element will be destroyed or collapsed.

Moreover, in FIG. 1-2, the prior art cut surfaces 422 of the adjustable spanner will cause that the adjusting jaw has a smaller area to be in contact with the surface of the fixing jaw so that it cannot provide a greater twisting force to the screwing elements.

Referring to FIG. 1-3, if the prior art adjustable spanner is used to drive a large screwing element, not only the larger sides of the screwing element can not be fully in contact with the clamping surfaces of the adjustable spanner so that the screwing element will wear from the contact points thereof, but also the full bottom of the adjusting jaw fully adheres to the surfaces aside the recess of the fixing jaw so that the twisting force cannot be effectively transferred to the screwing element.

### SUMMARY OF THE INVENTION

Accordingly, the primary object of the present invention is to provide a jaw portion structure of an adjustable spanner, wherein the screwing element is in surface-contact with the clamping surfaces of the adjustable spanner so that when a force is applied to the adjustable spanner body, the applied force can be uniformly distributed so as to prevent the screwing element to slide or collapse. Thus the lifetime of the adjustable spanner is prolonged.

To achieve above objects, the present invention provides A jaw portion structure of an adjustable spanner comprises an adjustable spanner body including a head portion and a handle; a fixing jaw portion and a sliding trench being extended integrally in the head portion; one side of the fixing jaw portion being formed with a second clamping surface. A movable jaw is installed in the sliding trench; one side of the movable jaw being formed with a first clamping surface corresponding to the second clamping surface; a lower end of the movable jaw being installed with a positioning rod which being positioned to the sliding trench of the head portion. A neck portion is formed between the positioning rod and the movable jaw. One side of the neck portion is formed with an inclined surface connected to the first clamping surface. Each of two sides of the inclined surface is formed with a respective cambered guide surface.

The various objects and advantages of the present invention will be more readily understood from the following detailed description when read in conjunction with the appended drawing.

### BRIEF DESCRIPTION OF THE DRAWINGS

FIGS. 1-1 to 1-3 show the prior art adjustable spanner which clamps different screwing element.

FIG. 2 is an exploded schematic view of the jaw portion structure of an adjustable spanner of the present invention.

FIG. 3 is a schematic view about the jaw portion structure of an adjustable spanner of the present invention.

FIGS. 4-1 to 4-3 show the operation of the jaw portion structure of an adjustable spanner of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

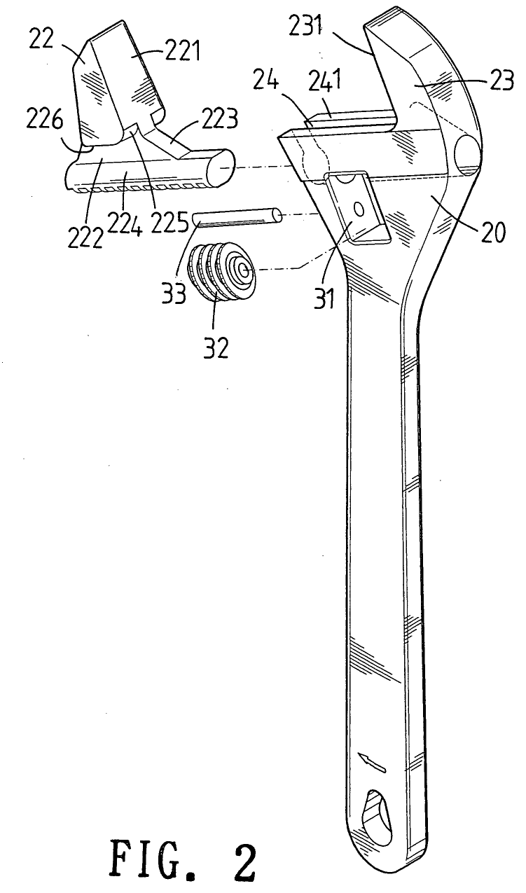

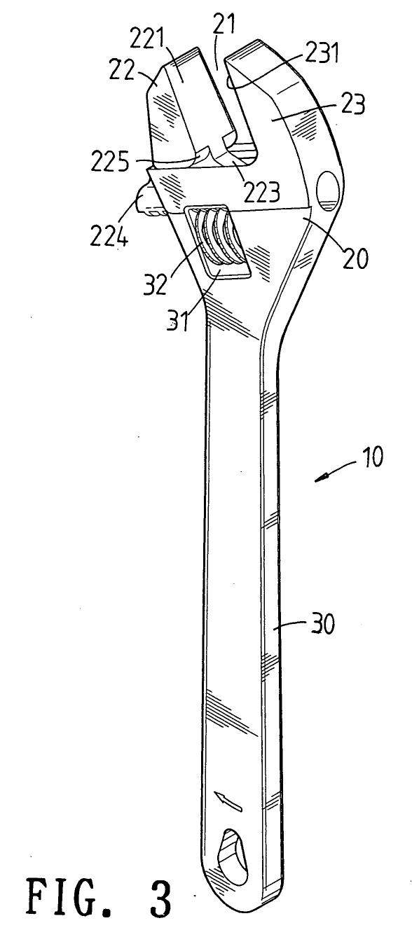

Referring to FIGS. 2 and 3, the jaw portion structure of an adjustable spanner of the present invention is illustrated. The present invention has the following elements.

The adjustable spanner body 10 of the present invention includes a head portion 20 and a handle 30.

A fixing jaw portion 23 and a sliding trench 24 are extended integrally in the head portion 20. One side of the fixing jaw portion 23 is formed with a second clamping surface 231. Each of two sides of the sliding trench 24 is formed with a respective third clamping surface 241.

A movable jaw 22 is installed in the sliding trench 24. One side of the movable jaw 22 is formed with a first clamping surface 221 corresponding to the second clamping surface 231. A lower end of the movable jaw 22 is installed with a positioning rod 224 which is positioned to the sliding trench 24 of the head portion 20. A neck portion 222 is formed between the positioning rod 224 and the movable jaw 22. One side of the neck portion 222 is formed with an inclined surface 223 connected to the first clamping surface 221. Each of two sides of the inclined surface 223 is formed with a respective cambered guide surface 225 at a position connected to the first clamping surface 221. Each of two sides of the neck portion 222 is formed with a respective contact surface 226 which is extended from the cambered guide surface 225. The contact surface 26 serves to contact a respective one of the third clamping surfaces 241.

Referring to FIG. 2, a longitudinal receiving portion 31 is formed in the head portion 20. The receiving portion 21 is communicable to the sliding trench 24. An adjusting device is installed within the receiving portion 21. The adjusting device includes an adjusting wheel set 32 and a pivotal rod 33. By the adjusting device in the receiving portion 31, the movable jaw 22 can be moved transversally.

Moreover, as shown in FIG. 3, in the present invention, the first clamping surface 221, second clamping surface 231 and third clamping surface 241 are formed as a U shape structure 21 for clamping a screwing element. The neck portion 222 is received within the sliding trench 24. Only part of the inclined surface 223 of the neck portion 222 and the cambered guide surface 225 are protruded out.

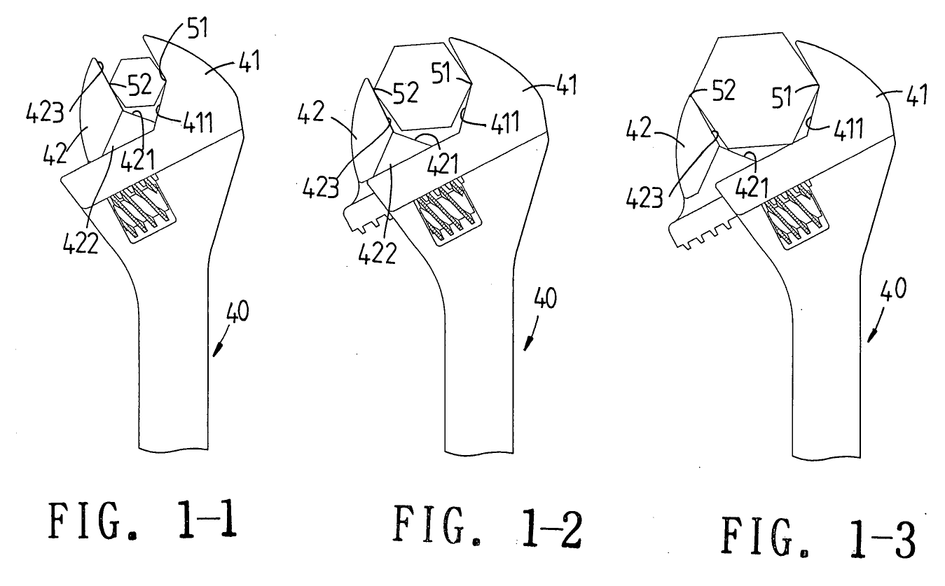

With reference to FIGS. 4-1 to 4-3, in the present invention, the lower end of the fixing jaw portion 23 has cambered guide surfaces 225 which are different from the inclined surface in the prior art. Thereby, the surfaces of the screwing element can be clamped by the first clamping surface 221 and the second clamping surface 231. When a force is applied to the adjustable spanner body 10, the applied force can be uniformly distributed so as to prevent the screwing element to slide or collapse. Thus the lifetime is prolonged.

Moreover, in the present invention, the cambered guide surface 225 of the movable jaw 22, the contact surfaces between the contact surfaces 226 and the third clamping surfaces 241 are enlarged so that the movable jaw 22 provides a larger supporting force and the movable jaw 22 is stable. Thereby, it is preferred to drive a rusted screwing element.

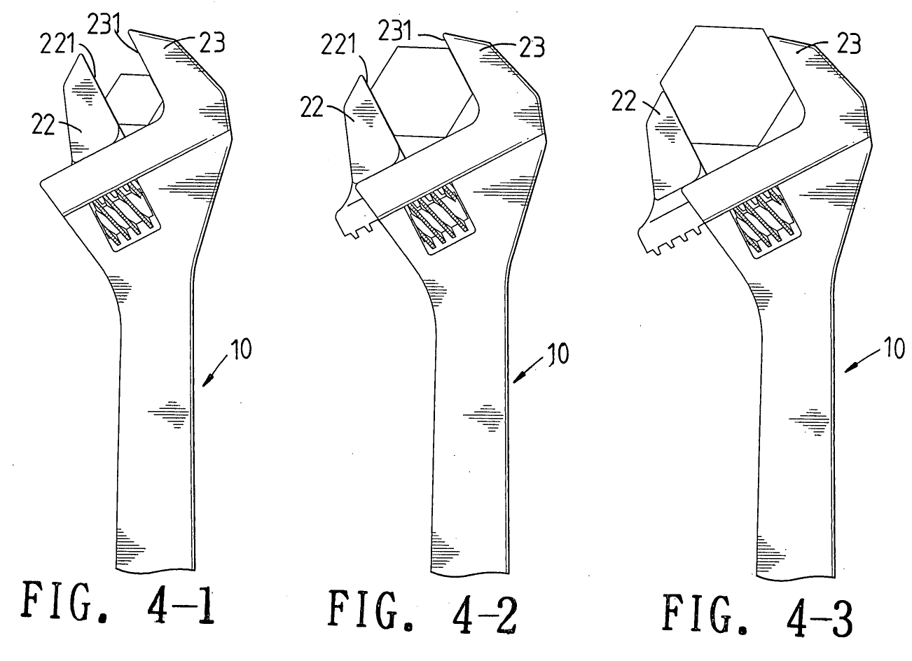

The contact surfaces at the bottom of the movable jaw 22 are prolonged so as to have a larger contact surface 226 with the third clamping surface 241, as shown in FIG. 4-3. Thereby, it is preferred to clamp a larger screwing element.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A jaw portion structure of an adjustable spanner comprising:
an adjustable spanner body including a head portion and a handle;
a fixing jaw portion and a sliding trench being extended integrally in the head portion; one side of the fixing jaw portion being formed with a second clamping surface;
a movable jaw being installed in the sliding trench; one side of the movable jaw being formed with a first clamping surface corresponding to the second clamping surface; a lower end of the movable jaw being installed with a positioning rod which is positioned to the sliding trench of the head portion; a neck portion being formed between the positioning rod and the movable jaw; one side of the neck portion being formed with an inclined surface connected to the first clamping surface; each of two sides of the inclined surface being formed with a respective cambered guide surface at a position connected to the first clamping surface.

2. The jaw portion structure of an adjustable spanner as claimed in claim 1, wherein the neck portion is received in the sliding trench.

3. The jaw portion structure of an adjustable spanner as claimed in claim 1, wherein each of two sides of the sliding trench is formed with a respective third clamping surface; each of two sides of the neck portion is formed with a respective contact surface which is extended from the cambered guide surface; and the contact surface serves to contact a respective one of the third clamping surfaces.
